(19) United States
(12) Patent Application Publication
(10) Pub. No.: US 2013/0307237 A1
(43) Pub. Date: Nov. 21, 2013

(54) MEDICAL CART SYSTEM

(71) Applicant: YAW-LIN CHEN, New Taipei City (TW)

(72) Inventor: YAW-LIN CHEN, New Taipei City (TW)

(73) Assignee: SYNCMOLD ENTERPRISE CORP., New Taipei City (TW)

(21) Appl. No.: 13/588,346

(22) Filed: Aug. 17, 2012

(30) Foreign Application Priority Data
May 21, 2012 (TW) 101118017

(51) Int. Cl. B62B 3/02

(52) U.S. Cl. 280/35

(57) ABSTRACT

The instant disclosure relates to a medical cart system, which includes a base, a tower, a work station, a quick-release unit, and a drawer assembly. The base is supported by wheels, and the tower is disposed on the top surface of the base. The work station is movably disposed on the tower. The work station includes at least one work platform disposed at the front of the tower and at least one display arranged above the work platform. The quick-release unit is removably disposed on the tower. The drawer assembly includes one cabinet removably disposed on the tower.

### BACKGROUND OF THE INVENTION

1. Field of the Invention

The instant disclosure relates to a push cart; more particularly, to a medical cart system.

2. Description of Related Art

The U.S. Pat. App. No. 2009/0212670 has disclosed a medical cart equipped with a drawer assembly. However, further improvements in convenience and flexibility for the drawer assembly are desirable.

### SUMMARY OF THE INVENTION

To address the abovementioned issues, the instant disclosure provides an improved medical cart system.

The medical cart system of the instant disclosure comprises a base, a tower, a work station, a quick-release unit, and a drawer assembly. The base is supported by a plurality of wheels. The tower is disposed on the top surface of the base. The work station, which includes at least one display, is movably disposed on the tower. The quick-release unit is detachably disposed on the tower. The drawer assembly includes one cabinet removably disposed on the tower via the quick-release unit.

The quick-release unit includes a first quick-release module. The first quick-release module includes a pair of first sliding members removably disposed on the tower and at least one first fastener removably connected between the first sliding members. The cabinet is removably disposed on one of the first sliding members.

The quick-release unit further includes a second quick-release module. The second quick-release module includes a pair of second sliding members removably disposed on the tower, a first locking member disposed on one of the second sliding members, and a second locking member disposed on the other second sliding member to work cooperatively with the first locking member. The second sliding members are positioned on the tower by the first and second locking members working cooperatively.

One of the quick-release modules is formed with at least one first groove. The cabinet includes an outer shell, a plurality of drawers movably disposed in the shell, and at least one first catch disposed externally on the shell for engaging the first groove. The cabinet is positioned on the tower via the engagement of the first catch into the first groove.

The medical cart system further includes an auxiliary unit. The auxiliary unit includes an arm pivotally disposed on the tower and a side display connected to the arm. The arm is removably disposed on the tower through one of the quick-release modules.

The tower includes a vertically extending post disposed on the base and a pair of tracks disposed on opposite sides of the post. The aforementioned cabinet is either a general purpose cabinet or a medication cabinet.

The medical cart system further includes a medical supply cart. The supply cart is formed with a receiving space to accommodate the medication cabinet.

The supply cart comprises a base supported on wheels and a lift movably disposed on the base.

The medication cabinet has at least one first locking structure formed on the top surface thereof. The lift has a second locking structure for engaging the first locking structure. The medication cabinet is positioned inside the receiving space through the engagement of the first and second locking structures.

The medication cabinet defines at least a pair of channels formed on opposite sides thereof. The lift has at least a pair of guide bars for engaging the channels. The medication cabinet can be slid in and out of the receiving space between a closed position and an open position.

The medical cart system further includes a medicine shelf. The medicine shelf defines a storage space to accommodate medications. The medicine shelf may be a wall-embedded shelf, a countertop shelf, or a wall-mount shelf.

The post includes a first frame vertically mounted on the base, a second frame vertically spaced above the first frame, and an intermediate frame removably connected between the first and second frames. The work station is movably disposed on the second frame.

For advantages, the medical cart system of the instant disclosure utilizes the quick-release unit to easily install and dismount the drawer assembly. As a result, when in operation, the flexibility and convenience of the medical cart system are enhanced.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an exploded view of a medical cart system of the instant disclosure.

FIG. 2 is a perspective view of the medical cart system installed with the general purpose cabinet and the auxiliary unit of the instant disclosure.

FIG. 3 is a perspective view of the medical cart system installed with the medication cabinet and the auxiliary unit of the instant disclosure.

FIG. 4 is a cross-sectional view of the tower, the first quick-release module, and a portion of the general purpose cabinet of the instant disclosure.

FIG. 5 is a cross-sectional view of the tower, the second quick-release module, and a portion of the auxiliary unit of the instant disclosure.

FIG. 6 is a cross-sectional view of the tower, the first quick-release module, and a portion of the medication cabinet of the instant disclosure.

FIG. 7A is a front view of the medication cabinet at unelevated position inside the receiving space of the medical supply cart of the instant disclosure.

FIG. 7B is a front view of the medication cabinet at elevated position inside the receiving space of the medical supply cart of the instant disclosure.

FIG. 8 is a schematic view showing the medical supply cart in use with the wall-embedded shelf of the instant disclosure.

FIG. 9 is a schematic view showing the countertop shelf and the wall-mount shelf of the instant disclosure.

### DETAILED DESCRIPTION OF EMBODIMENTS

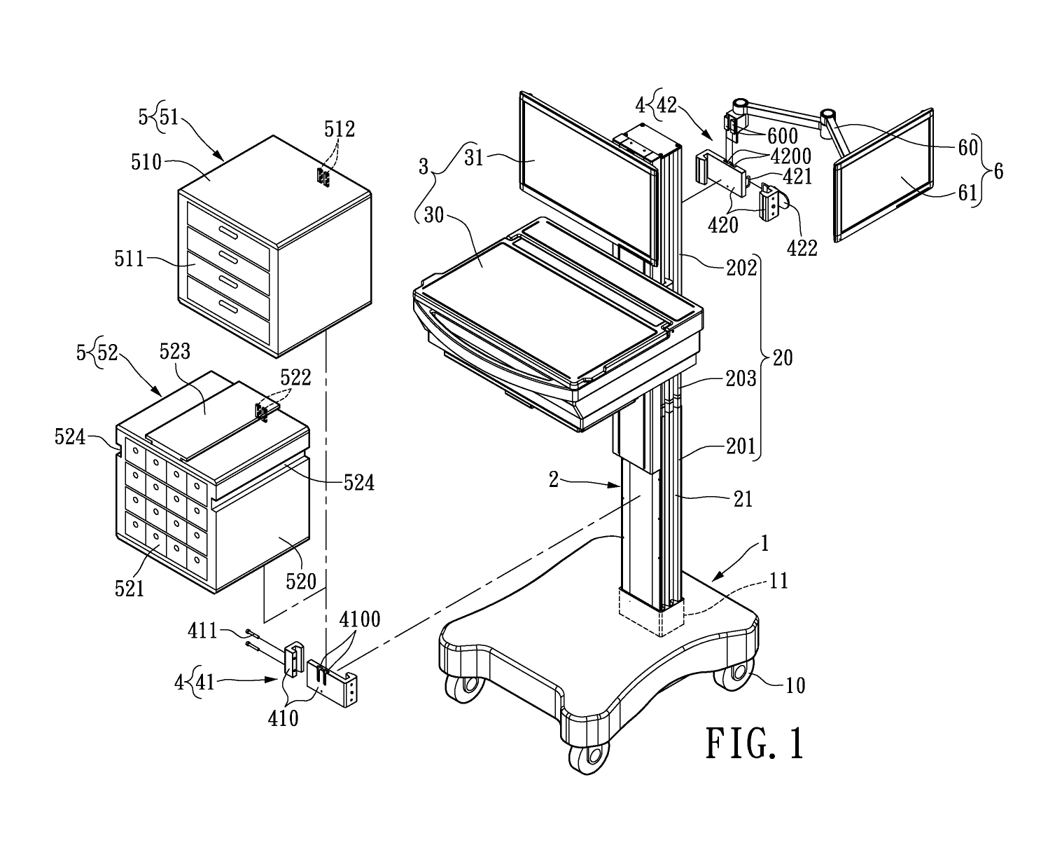

Please refer to FIGS. 1-3. The instant disclosure provides a medical cart system, which comprises a base 1, a tower 2, a work station 3, a quick-release unit 4, a drawer assembly 5, and an auxiliary unit 6.

As shown in FIG. 1, the base 1 is supported on wheels 10. The base 1 is formed with a recess 11 on the top surface thereof for inserting the tower 2. A battery or an uninterruptible power supply (UPS) is stored inside the base 1 to power the medical cart system.

Please still refer to FIG. 1, which shows the tower 2 is mounted on the top surface of the base 1. The tower 2 includes a vertically extending post 20 disposed on the top surface of the base 1 and at least a pair of tracks 21 arranged on opposite sides of the post 20. One end of the post 20 is received by the recess 11 of the base 1, such that the post 20 is held securely by the base 1. The post 20 may also be constructed by a series of frames. For example, the post 20 may include a first frame 201 vertically mounted on the base 1, a second frame 202 arranged spaced vertically above the first frame 201, and an intermediate frame 203 removably connected between the first and second frames 201 and 202. The multi-segmented post 20 is advantageous for shipping. Namely, for the scenario when the post 20 is broken into the first frame 201, the second frame 202, and the intermediate frame 203, the post 20 takes up less space longitudinally. As a result, the shipping process is easier and less expensive.

Please refer back to FIG. 1. The work station 3 is movably disposed on the tower 2. The work station 3 includes a work platform 30 disposed on the front of the tower 2 and a display 31 arranged above the work platform 30. For example, the work station 3 may be movably disposed on the second frame 202 of the post 20. The work platform 30 and the display 31 may be simultaneously driven up and down relative to the tower 2 by a lift mechanism (not shown) disposed thereon. However, the work platform 30 and the display 31 may also be configured to displace independently of each other. The exact height of the work platform 30 and the display 31 may be adjusted according to the needs of the user.

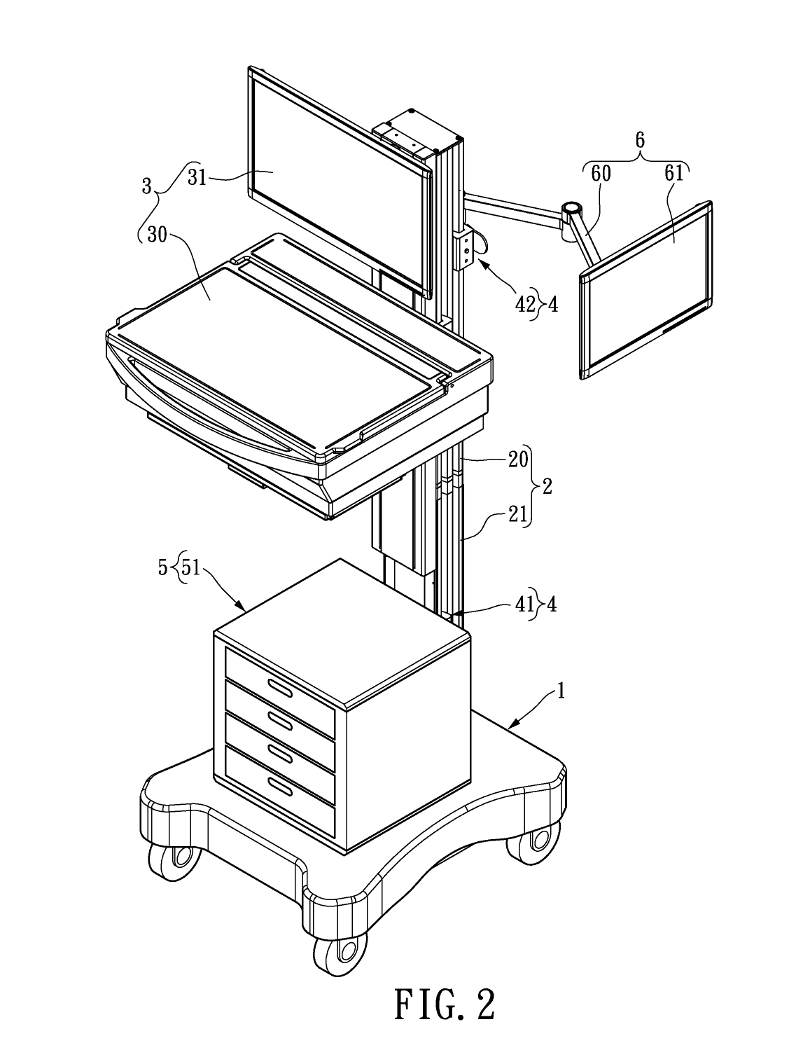

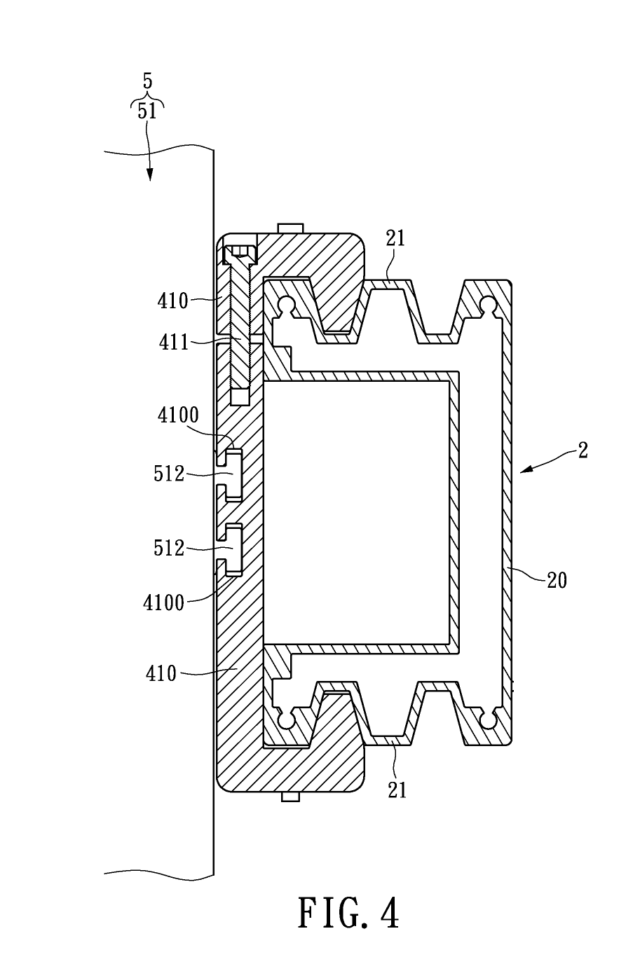

Please refer to FIGS. 2 and 4 in conjunction with FIG. 1. The quick-release unit 4 includes at least one first quick-release module 41 removably disposed on the tower 2 and between the base 1 and the work station 3. The first quick-release module 41 includes a pair of first sliding members 410 removably disposed on opposite tracks 21 and at least one first fastener (e.g., screw) removably connected between the first sliding members 410. One of the first sliding members 410 is formed with at least one first groove 4100. In the illustrated embodiment, two first grooves 4100 are provided on one of the first sliding members 410. Each first groove 4100 is substantially T-shaped. The separation distance between the first sliding members 410 is adjustable by tightening (i.e., turning the screw in a clock-wise direction) and loosening (i.e., turning the screw in a counter clock-wise direction) the first fastener 411. When the first fastener 411 is loosen, the first sliding members 410 are free to move upward and downward along the post 20. Thus, the first sliding members 410 are height adjustable. After the first sliding members 410 have reached a desired height, the first fastener 411 can be tightened to lock the first sliding members 410 on the tracks 21. At the locked state, the first sliding members 410 can no longer be moved upward or downward along the post 20. The drawer assembly 5 can then be engaged or disengaged to and from the first grooves 4100 as will hereinafter be described.

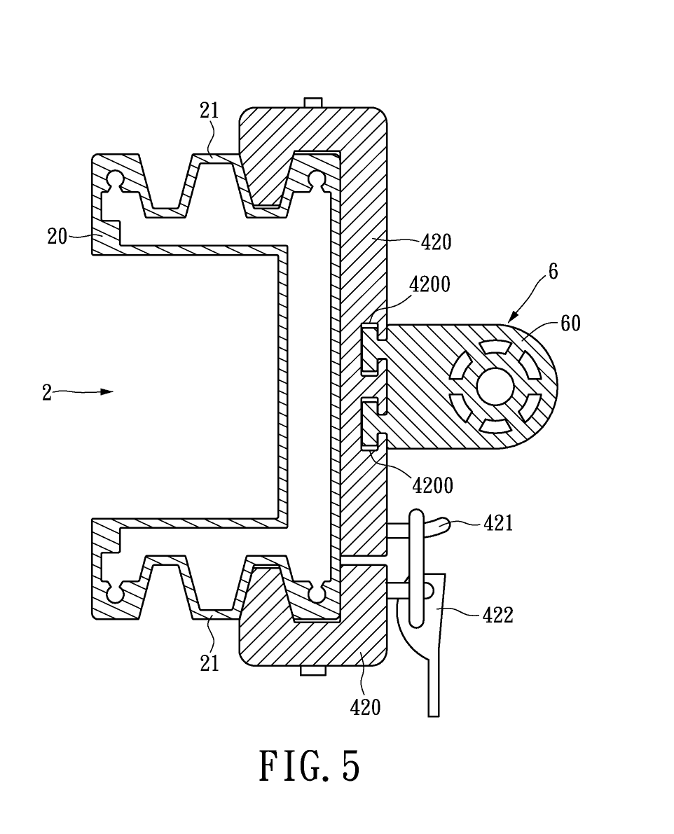

Please refer to FIGS. 2 and 5 in conjunction with FIG. 1. The quick-release unit 4 further includes at least one second quick-release module 42 removably mounted to the back of the tower 2. For example, the second quick-release module 42 includes a pair of second sliding members 420 removably disposed on the tracks 21, a first locking member 421 (e.g., eyelet) disposed on one of the second sliding members 420, and a second locking member 422 (e.g., a retaining ring) disposed on the other second sliding member 420 for engaging the first locking member 421. The second sliding members 420 are locked on the post 20 via the engagement of the first locking member 421 with the second locking member 422. Likewise, one of the second sliding members 420 is formed with at least one second groove 4200. The second sliding members 420 can be mounted to or removed from the post 20 by engaging or disengaging the first and second locking members 421 and 422. The auxiliary unit 6 can then be removably engaged to the second groove 4200. Further, the second groove 4200 may be omitted if the auxiliary unit 6 is formed integrally with one of the second sliding members 420. Alternatively, the positions of the first quick-release unit 41 and the second quick-release unit 42 may be reversed. As a result, the drawer assembly 5 and the auxiliary unit 6 may be removably disposed on the post 20 via the second quick-release unit 42 and the first quick-release unit 41, respectively.

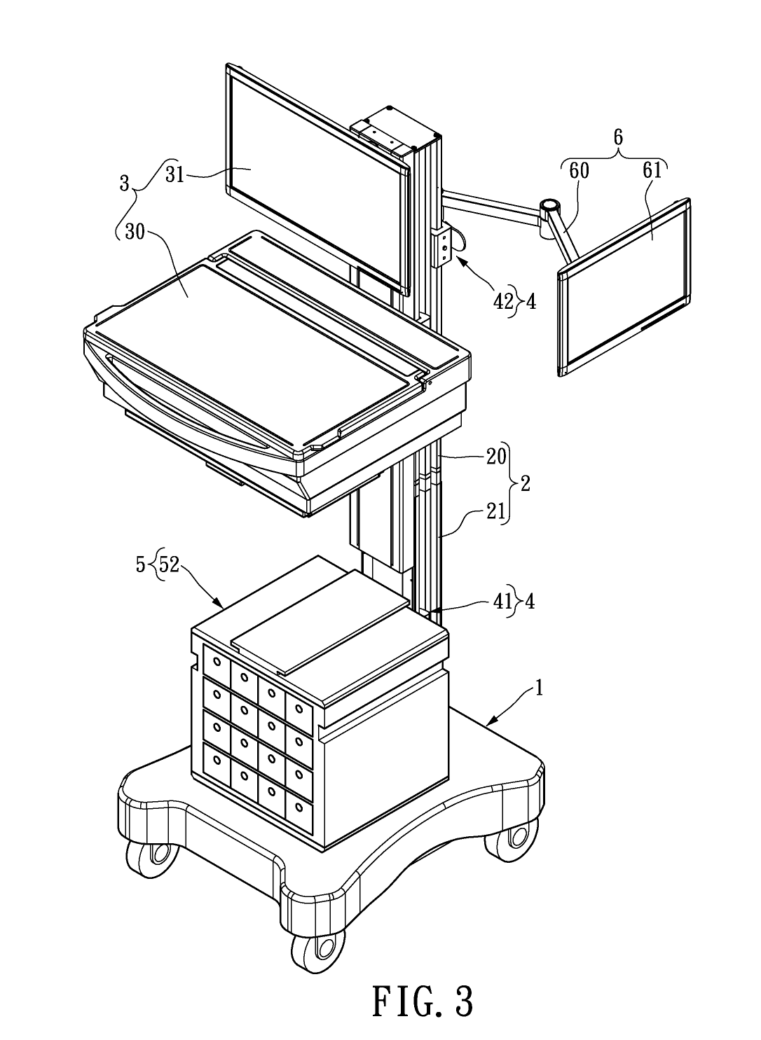

As shown in FIG. 1, at least two types of cabinets are available for selection by the user. In operation, as shown in FIGS. 2 and 3, either cabinet is removably disposed on the tower 2 via the first quick-release module 41. For example, the two types of cabinets may be a general purpose cabinet 51 (have four large drawers used by the medical staff while in the patient room) and a medication cabinet 52 (e.g., having sixteen small drawers for storing medications). As previously mentioned, while the medical cart system is in use, only one of the abovementioned cabinets is removably disposed to the front of the post 20.

Specifically, in operation, the general purpose cabinet 51 or the medication cabinet 52 is removably disposed on one of the first sliding members 410 in a convenient and easy manner.

Please refer to FIGS. 1, 2, and 4. The general purpose cabinet 51 includes an outer shell 510, a plurality of drawers 511 movably disposed in the outer shell 510, and at least one first catch 512 disposed on the outer shell 510 for engaging the first groove 4100. In the illustrated embodiment two first catches 512 are provided for engaging the first grooves 4100. The user may removably dispose the general purpose cabinet 51 on one of the first sliding members 410 (as shown in FIGS. 2 and 4) via the engagement between the first catches 512 and the first grooves 4100. Thus, the general purpose cabinet 51 can be quickly mounted to the post 20. To remove the general purpose cabinet 51 from the post 20, the user only needs to disengage the first catches 512 from the first grooves 4100 toward an upward direction. Thus, the general purpose cabinet 51 can be dismounted with ease.

Likewise, the medication cabinet 52 includes an outer shell 520, a plurality of drawers 521 movably disposed in the outer shell 520, at least one second catch 522 disposed on the outer shell 520 for engaging the first groove 4100, a first locking structure 523 formed on the top surface of the outer shell 520, and at least a pair of channels 524 formed on opposite sides of the outer shell 520. In the illustrated embodiment two second catches 522 are provided for engaging the first grooves 4100. The mounting and dismounting of the medication cabinet 52 on the post 20 are substantially the same as the general purpose cabinet 51, thus no further description is provided herein.

For the auxiliary unit 6, please refer to FIGS. 1, 2 and 5. The auxiliary unit 6 includes an arm 60 connected to a side display 61 at the back of the tower 2. However, the exact configuration is not restricted thereto. The arm 60 is removably connected to the tower via the second quick-release module 42. Specifically, the arm 60 is removably disposed on one of the second sliding members 420. Thus, the arm 60 may be mounted or dismounted to and from the post 20 in a convenient and easy manner. For example, the arm 60 is formed with at least one second catch 600 on one end thereof for engaging the second groove 4200. The arm 60 is positioned on the post 20 via the engagement between the second catch 600 and the second groove 4200. In other words, the user only needs to engage the second catches 600 of the auxiliary unit 6 with the second grooves 4200 to quickly mounting the auxiliary unit 6 on the post 20. To remove the auxiliary unit 6 from the post 20, the user only needs to pull the second catches 600 away from the second grooves 4200 in an upward direction to quickly dismount the auxiliary unit 6. In operation, the auxiliary unit 6 may include other devices and is not limited to the side display 61.

It should be noted more complex designs of first and second quick-release modules 41 and 42 may be used for mounting the drawer assembly 5 and the auxiliary unit 6. However, more mounting and dismounting time may be required. Such effect is undesirable and may reduce the efficiency of workflow for the medical staffs. The “add-on” capabilities of the medical cart system would be less helpful than what was originally planned.

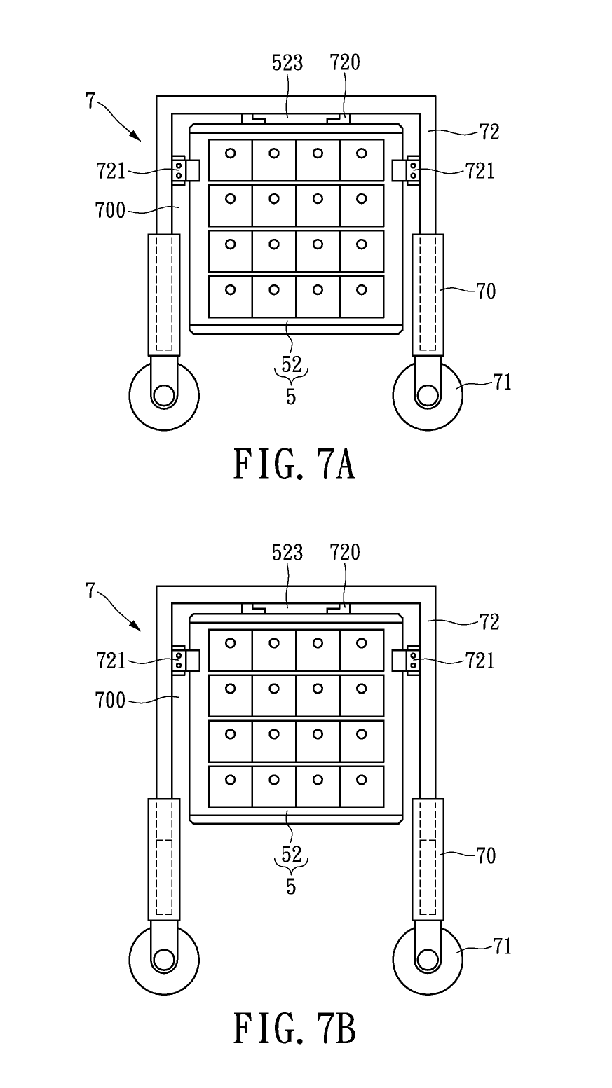

Please refer to FIGS. 1, 7A, and 7B. The medical cart system of the instant disclosure further comprises a medical supply cart 7. For example, the nursing staff may roll the cart 7 to the hospital pharmacy, and the pharmacists can refill the medical supply, such as by arranging medication in the cabinet 52. The cart 7 defines a receiving space 700 to accommodate the medication cabinet 52. The receiving space 700 may be dimensioned to receive more than one medication cabinet 52. The cart 7 includes a base 70 supported on wheels 71, a lift 72 movably disposed on the top surface of the base 70, and a second locking structure 720. The second locking structure 720 is utilized for engaging the first locking structure 523 to position the medication cabinet 52 in the receiving space 700. The medication cabinet 52 may be driven upward (FIG. 7B) and downward (FIG. 7A) by the lift 72. Thus, the medication cabinet 52 is height-adjustable.

The lift 72 further includes a pair of elongated and movable guide bars 721 for inserting into the channels 524 of the medication cabinet 52. The medication cabinet 52 may be disposed between a closed position inside the receiving space 700 and an open position out of the receiving space by the guide bars 721. When the guide bars 721 are slid out of the receiving space 700, the guide bars 721 may slip into the channels 524 of the medication cabinet 52, such that the medication cabinet 52 is arranged in between the guide bars 721. Once the guide bars 721 and the medication cabinet 52 have slide back into the receiving space 700, the medication cabinet 52 is positioned securely inside the receiving space 700 by the engagement of the first locking structure 523 of the medication cabinet 52 with the second locking structure 720 of the cart 7.

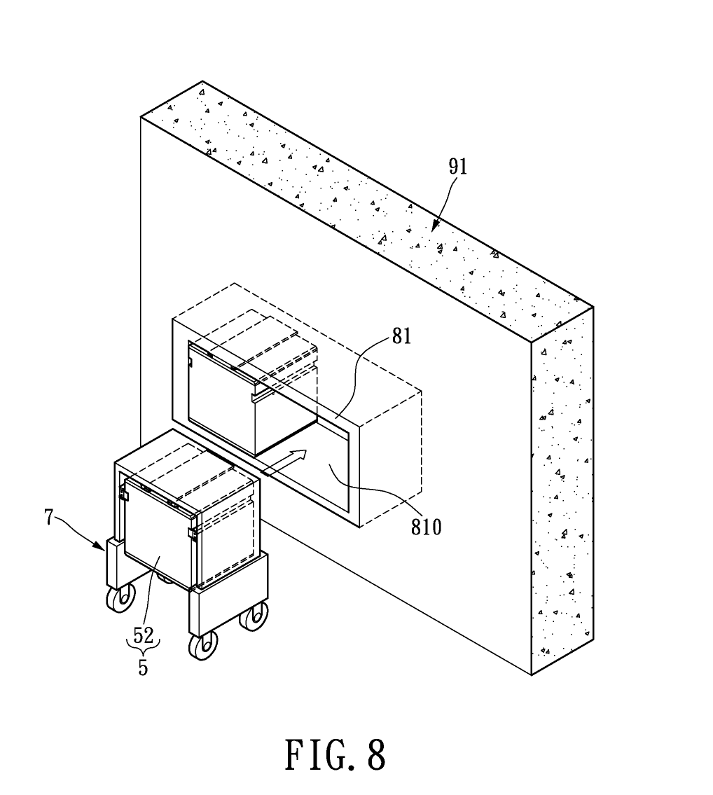

Please refer to FIG. 8 in conjunction with FIGS. 7A and 7B. The medical cart system further includes a wall-embedded shelf 81. The shelf 81 defines a storage space 810 for receiving the medication cabinet 52. The shelf 81 penetrates a wall 91 entirely. In operation, after the medical staff has transported the medication cabinet 52 by the cart 7 to the pharmacist, the medication cabinet 52 may be transferred into the storage space 810 by the guide bars 721. The drawers 521 are facing away from the medical staff and toward the pharmacist for refill. It should be noted if the height of the storage space 810 is substantially the same as that of the medication cabinet 52 on the tower 2, the cart 7 may be omitted. However, for such scenario, some type of handling device similar to the guide bars 721 needs to be provided inside the storage space 810 to facilitate transporting the medication cabinet 52.

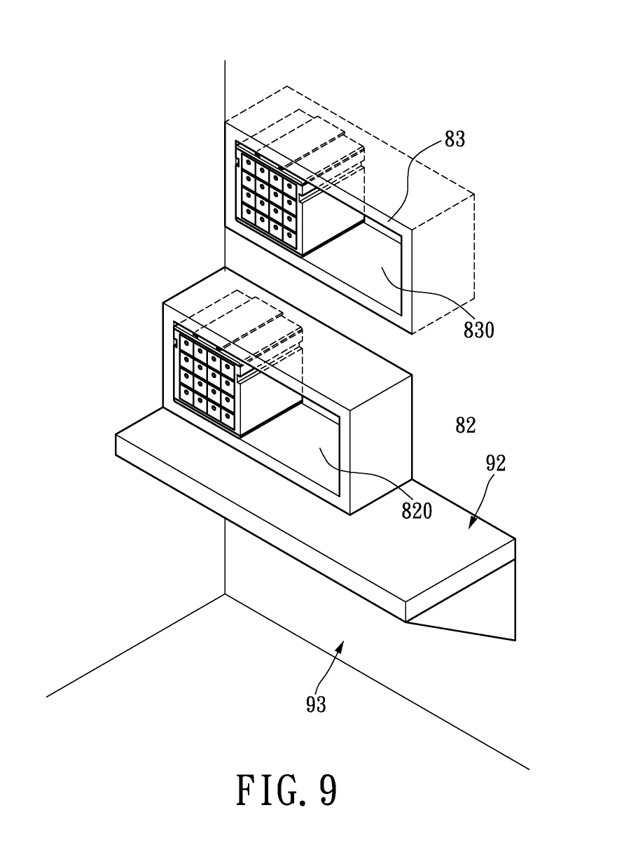

Further, as shown in FIG. 9, the wall-embedded shelf 81 may be replaced by a countertop shelf 82. Likewise, the countertop shelf 82 is formed with a storage space 820 to accommodate the medication cabinet 52. The countertop shelf 82 is typically disposed on a counter 92. After the medical staff has transported the medication cabinet 52 to the pharmacist by the cart 7, the medication cabinet 52 may be slid out to the open position by the guide bars 721. The medical staff may then relocate the medication cabinet 52 to the storage space 820 of the countertop shelf 82.

Alternatively, as shown in FIG. 9, the wall-embedded shelf 81 may be replaced by a wall-mount shelf 83. The wall-mount shelf 83 is formed with a storage space 830 to receive the medication cabinet 52. The wall-mount shelf 83 is disposed on a wall 93. After the medical staff has transported the medication cabinet 52 to the pharmacist by the cart 7, the medication cabinet 52 may be slid out to the open position by the guide bars 721. The medical staff may then relocate the medication cabinet 52 to the storage space 830 of the wall-mount shelf 83.

Based on the foregoing, the medical cart system of the instant disclosure utilizes the first quick-release module 41 to removably dispose the general purpose cabinet 51 or the medication cabinet 52 to the front of the post 20. The second quick-release module 42 is also utilized to removably dispose the auxiliary unit 6 to the back of the post 20. Based on the needs of the medical staff, the medical staff can quickly replace the general purpose cabinet 51, the medication cabinet 52, and the auxiliary module 6 via the first and second quick-release modules 41 and 42. When in operation, the general purpose cabinet 51 (FIG. 2) or the medication cabinet 52 (FIG. 3) is removably disposed on the tower 2 to meet the needs of the medical staff.

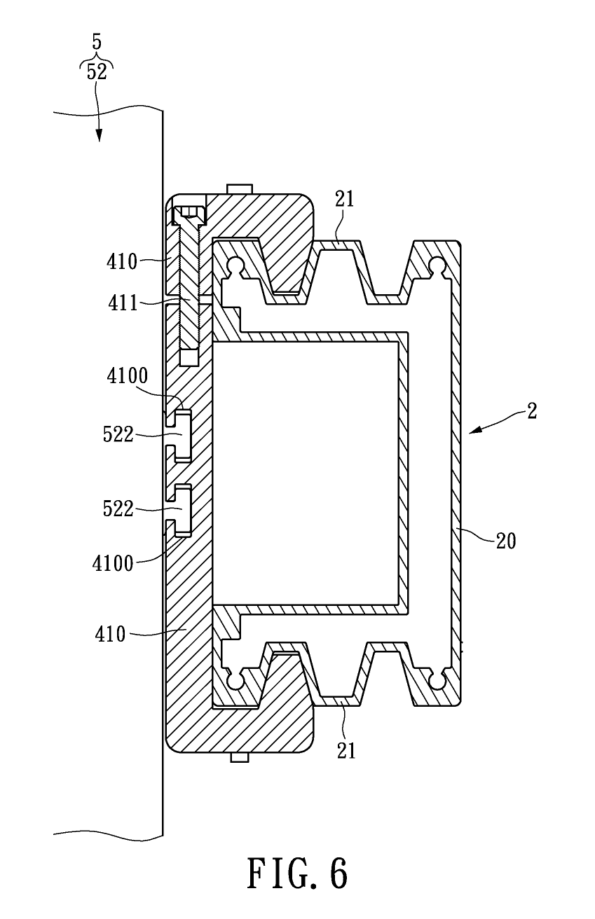

When the medical staff is visiting the patient rooms, the general purpose cabinet 51 may be removably disposed on the tower 2 via the first quick-release module 41 (as shown in FIGS. 2 and 4). When the medical staff needs to take the medication cabinet 52 to the pharmacist for refill, the medication cabinet 52 may be removably disposed on the tower 2 via the first quick-release module 41 (as shown in FIGS. 3 and 6). After the medication cabinet 52 is removed from the tower 2, the medical staff can mount the general purpose cabinet 51 on the tower 2 (as shown in FIG. 2) to visit the patient rooms. After the medical staff has finished visiting the patient rooms, the general purpose cabinet 51 may be replaced with the medication cabinet 52 from the pharmacist to provide the medicine to the patients. Since the medical cart system of the instant disclosure is adaptable to the general purpose cabinet 51 and the medication cabinet 52, the medical cart system does not have to remain idle.

The descriptions illustrated supra set forth simply the preferred embodiment of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A medical cart system, comprising:
a base supported on wheels;
a tower disposed on the top surface of the base;
a work station movably disposed on the tower, the work station including at least one display;
a quick-release unit detachably disposed on the tower; and
a drawer assembly including one cabinet that is detachably mounted on the tower by the quick-release unit.

2. The medical cart system of claim 1, wherein the quick-release unit includes a first quick-release module, the first quick-release module having a pair of first sliding members removably disposed on the tower and at least one fastener removably connected between the first sliding members, while one of the cabinets is removably disposed on one of the first sliding members.

3. The medical cart system of claim 2, wherein the quick-release unit includes a second quick-release module, the second quick-release module having a pair of second sliding members removably disposed on the tower, a first locking member disposed on one of the second sliding members, a second locking member disposed on the other second sliding member, and wherein the first locking member is engageable with the second locking member to lock the second sliding members on the tower.

4. The medical cart system of claim 3, wherein one of the first quick-release module and the second quick-release module defines at least one first groove, wherein each cabinet has an outer shell, a plurality of drawers disposed in the outer shell, and at least one first catch disposed on the outer shell for engaging the first groove, and wherein one of the cabinets is positioned on the tower by the engagement between the first catch and the first groove.

5. The medical cart system of claim 3, further comprising an auxiliary unit that includes an arm removably disposed on the tower and a side display connected to the arm, wherein the arm is removably disposed on the tower by one of the first quick-release module and the second quick-release module.

6. The medical cart system of claim 3, wherein the tower includes a vertically extending post disposed on the top surface of the base and at least a pair of tracks disposed on opposite sides of the post, and wherein the cabinet is a general purpose cabinet.

7. The medical cart system of claim 3, wherein the tower includes a vertically extending post disposed on the top surface of the base and at least a pair of tracks disposed on opposite sides of the post, and wherein the cabinet is a medication cabinet.

8. The medical cart system of claim 7, further comprising a medical supply cart that defines a receiving space to accommodate the medication cabinet.

9. The medical cart system of claim 8, wherein the medical supply cart includes a base, a plurality of wheels mounted to the bottom surface of the base, and a lift movably mounted to the top surface of the base.

10. The medical cart system of claim 9, wherein the medication cabinet has a first locking structure formed on the top surface thereof, while the lift has a second locking structure for engaging the first locking structure to securely position the medication cabinet inside the receiving space.

11. The medical cart system of claim 9, wherein the medication cabinet is formed with at least a pair of channels on opposite sides thereof, and wherein the lift has at least a pair of movable guide bars capable of engaging the channels to position the medication cabinet between a closed position in the receiving space and an open position away from the receiving space.

12. The medical cart system of claim 7, further comprising a medicine shelf that defines a storage space to receive the medication cabinet, wherein the medicine shelf is a wall-embedded shelf.

13. The medical cart system of claim 7, further comprising a medicine shelf that defines a storage space to receive the medication cabinet, wherein the medicine shelf is a countertop shelf.

14. The medical cart system of claim 7, further comprising a medicine shelf that defines a storage space to receive the medication cabinet, wherein the medicine shelf is a wall-mount shelf.

15. The medical cart system of claim 6, wherein the post includes a vertically extending first frame disposed on the top surface of the base, a second frame disposed above the first frame by a predetermined space, and an intermediate frame removably connected between the first frame and the second frame, and wherein the work station is movably disposed on the second frame.

16. The medical cart system of claim 7, wherein the post includes a vertically extending first frame disposed on the top surface of the base, a second frame disposed above the first frame by a predetermined space, and an intermediate frame removably connected between the first frame and the second frame, and wherein the work station is movably disposed on the second frame.
